(19) United States
(12) Patent Application Publication
(10) Pub. No.: US 2003/0196865 A1
(43) Pub. Date: Oct. 23, 2003

(54) Power controlling device for four-wheel drive vehicle

(76) Inventor: Jung-Hyo Lim, Seoul (KR)

Correspondence Address: Pennie & Edmonds, LLP, 3300 Hillview Avenue, Palo Alto, CA, 94304, US

(21) Appl. No.: 10/215,556

(22) Filed: Aug. 8, 2002

(30) Foreign Application Priority Data
Apr. 18, 2002 (KR) 2002-21329

(51) Int. Cl. B60K 23/08; F16D 27/118

(52) U.S. Cl. 192/84.92; 192/84.93; 192/69.9; 180/247

(57) ABSTRACT

Disclosed is a power controlling device for a four-wheel drive vehicle capable of shifting a stable drive mode. The power controlling device includes an electromagnet 200, and a shift rod 210 operated by a magnetic field generated by the electromagnet 200 and having a fork 220 formed on one side thereof for operating the differential clutch gear 110, and a return spring 230 for constantly biasing the shift rod toward its original position.

### FIELD OF THE INVENTION

The present invention relates to a power control device for a four-wheel drive vehicle, and more particularly, to a power control device for a four-wheel drive vehicle capable of providing a stable drive mode.

### BACKGROUND OF THE INVENTION

In general, a four-wheel drive vehicle with a part-time four-wheel drive system includes a propeller shaft, a differential, a drive shaft, and so forth, so as to transfer a driving power to the front wheels only according to the selection of the driver. FIG. 1 is a cross sectional view illustrating a conventional front-wheel transmission of such a four-wheel drive vehicle. The power transmitted through a transfer 10 drives a pinion gear engaged to a transmission shaft 20, and then is transmitted to left and right wheel drive shafts 50a and 50b through a ring gear meshed with the pinion gear.

If the four-wheel drive vehicle is driven by only rear-wheel drive, the rotating force transmitted from front wheels causes the transmission shaft 20, the pinion gear, ring gear and wheel drive shafts 50a and 50b to be idled, thereby increasing gear noise and thus lowering fuel economy.

To address the above problem, Japanese Laid-Open Patent Publication Nos. 2001-50303 and 1999-303898 disclose a device for interrupting a portion of front-drive lines to minimize the number of idling parts when the power is not transferred to the front wheels. According to the above publications, the means interrupts the power outputted from the transfer to interrupt the idling parts, thereby preventing wear and damage of main clutch due to the idle. In addition, the device interrupts a mechanism interrupting the power transmission shaft 20, the pinion gear, and the ring gear and the wheel drive shafts 50a and 50b, thereby reducing the wear and noise of the idling parts.

FIG. 2 shows an embodiment of another power controlling device for use in a four-wheel drive vehicle, the power controlling device including an actuator 60 for interrupting transmitted power. The actuator 60 uses vacuum pressure generated from the engine as an actuating source, and sets any one of two chambers in the actuator at a vacuum state by controlling a solenoid valve so as to operate a shift rod 70. A fork 72 coupled to the shift rod and a sleeve interrupt a clutch gear, thereby preventing the idle of the transmission shaft in the two-wheel drive state and allowing the normal transmission in the four-wheel drive state. However, the vacuum pressure generated by the engine is generally not uniform. Therefore, it is difficult to achieve stable operation of the actuator.

In addition, the interruption of the clutch gear is performed by the solenoid valve, actuator and so forth. An excessive space containing the above parts is required. Furthermore, the need of separate lines for supplying the vacuum pressure causes the interior construction of the vehicle to be complicated, and the assembling efficiency to be reduced.

### SUMMARY OF THE INVENTION

The present invention provides a power control device for use in a four-wheel drive vehicle with a part-time system, in which one side of a differential is connected to a differential clutch gear and a connecting shaft clutch gear. The power control device preferably comprises an electromagnet, a shift rod operated by a magnetic field generated by the electromagnet to operate the differential clutch gear, and a return spring. The spring is positioned between the electromagnet and the shift rod, for constantly biasing the shift rod toward an original position thereof. Preferably, the electromagnet is positioned within an interior of the differential case, and an electric current is applied to the electromagnet from the electric power of the vehicle. The shift rod also preferably has on one end thereof a fork engaging to the differential clutch gear.

In a further alternative embodiment, a connecting shaft clutch gear delivers drive power to the front wheels of the vehicle through a differential. To selectively control actuation of the front wheels and differential components, a differential clutch gear is moveably disposed for selective cooperation with the connecting shaft clutch gear. A rod member is slidably disposed adjacent the differential clutch gear. The rod member cooperates with the differential clutch gear to impart axial translation thereto. An electromagnet is disposed to act on the rod member to move the member in a first direction when activated. A spring member acts on the rod member to move the rod member in an opposite direction when the electromagnet is deactivated. Preferably, a fork member extends from the rod member to engage the differential clutch gear.

It is to be understood that both the foregoing general description and the following detailed description of the present invention are exemplary and explanatory and are intended to provide further explanation of the present invention as claimed.

### BRIEF DESCRIPTION OF THE DRAWINGS

The accompanying drawings, which are included to provide a further understanding of the present invention and are incorporated in and constitute a part of this application, illustrate embodiment of the present invention and together with the description serve to explain the principles of the present invention. In the drawings:

FIG. 1 is a cross sectional view illustrating the construction of a conventional front-wheel transmission for use in a four-wheel drive vehicle;

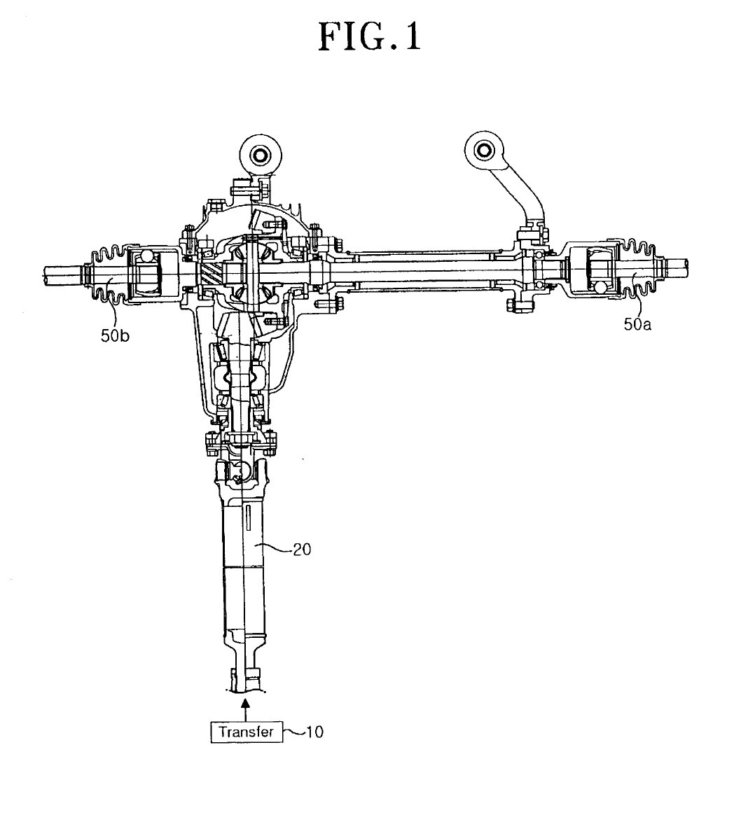

FIG. 2 is a cross sectional view illustrating the construction of a conventional power controlling device operating an actuator by use of a vacuum pressure of an engine;

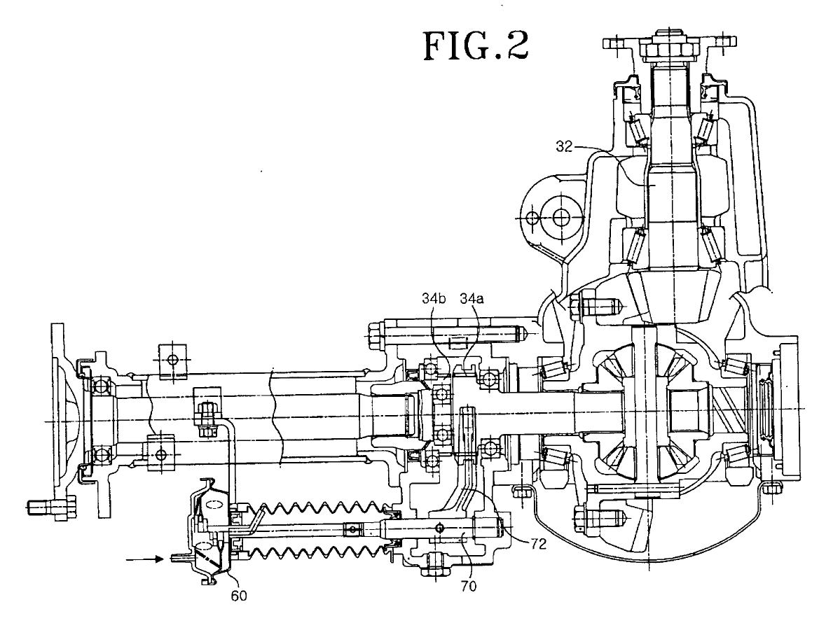

FIG. 3 is a cross sectional view illustrating the construction of a power control device according to a preferred embodiment of the present invention;

FIG. 4 is a circuit diagram of a power control device according to a preferred embodiment of the present invention;

FIG. 5 is a view illustrating the four-wheel drive state of a power control device according to the present invention; and

FIG. 6 is a view illustrating the two-wheel drive state of a power control device according to the present invention.

### DETAILED DESCRIPTION OF THE PREFERRED EMBODIMENTS

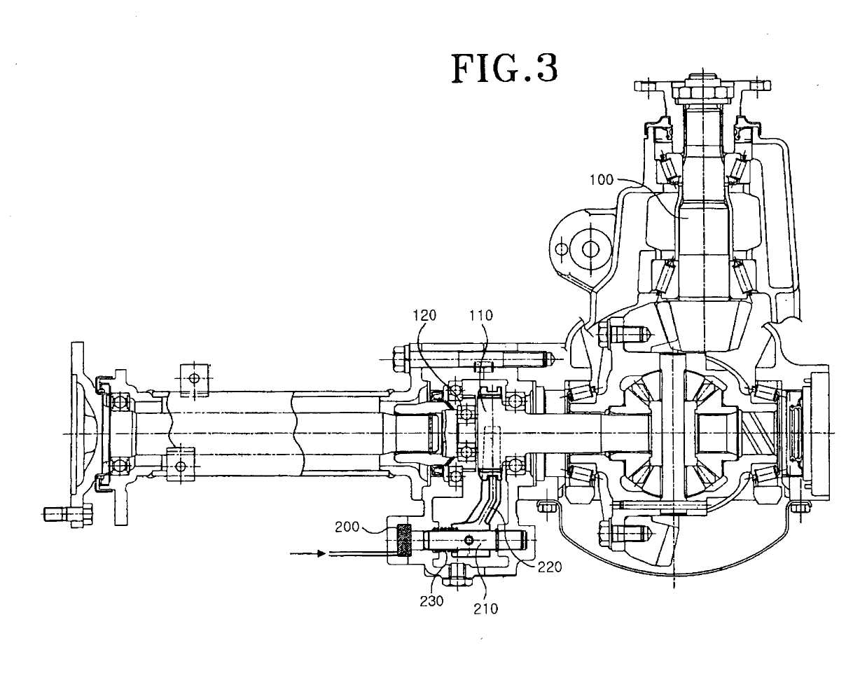

Referring to FIG. 3, a differential clutch gear 110 and a connecting shaft clutching gear 120 are installed to one side of a differential case. In order to interrupt the connection between the differential clutch gear 110 and the connecting shaft clutching gear 120, the present invention preferably includes an electromagnet 200, and a shift rod 210 operated by a magnetic field generated by the electromagnet 200. A fork 220 is formed on one side thereof for operating the differential clutch gear 110. A return spring 230 constantly biases the shift rod toward its original position.

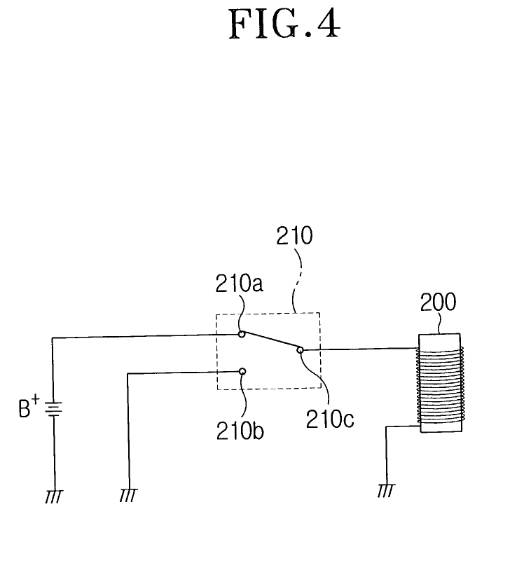

As shown in FIG. 4, the electromagnet 200 is connected to a drive shifting switch 201 preferably provided in the cabin of the vehicle, and is connected to a terminal B+ of a battery of the vehicle. If the drive shifting switch 201 is shifted to select four-wheel drive mode, a four-wheel drive terminal 201a is connected to an output terminal 201c, so that the electromagnet 200 is energized to form a magnetic field. If the drive shifting switch 201 is shifted to select two-wheel drive mode, a two-wheel drive terminal 201b is connected to the output terminal 201c, so that the electromagnet 200 is deenergized.

The electromagnet preferably may employ a common iron core, but as an alternative an electromagnet employing a superconductor having a high critical magnetic field may be used.

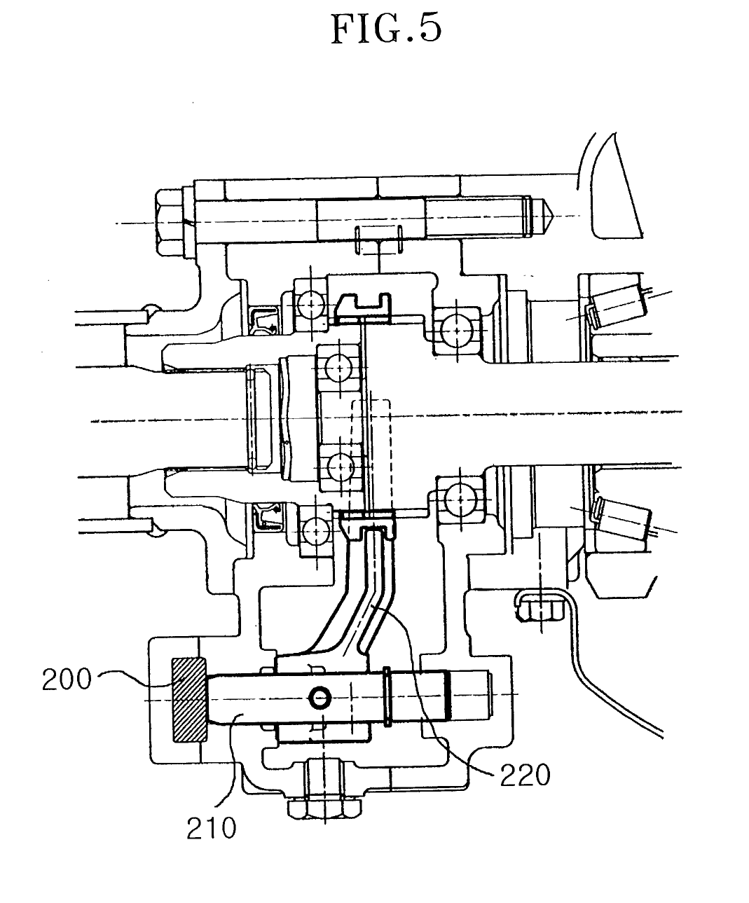

When the drive shifting switch 201 is shifted to select the four-wheel drive mode, the magnetic field formed by electromagnet 200 attracts the shift rod 210, as shown in FIG. 5. Since the fork 220 is attached to one side of the shift rod 210, and the differential clutch gear is connected to the fork 220, the differential gear is moved and meshed with the connecting shaft clutch gear in accordance with the movement of the shift rod 210 toward the electromagnet 200 due to the generated magnetic field. Accordingly, the wheel drive shaft is rotated by the driving force transmitted through the transmission shaft to engage the four-wheel drive.

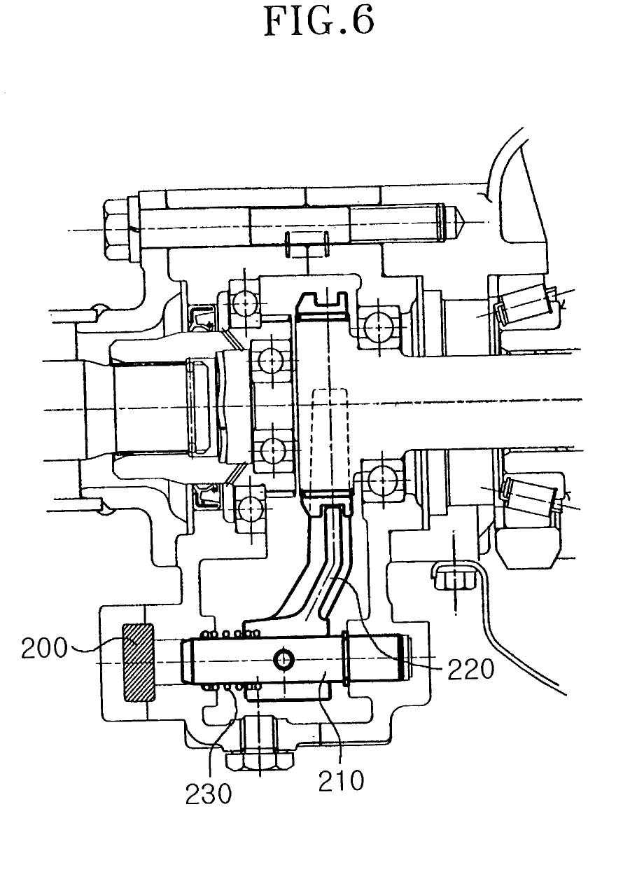

When the drive shifting switch 201 is shifted to select the two-wheel drive mode, the electromagnet 200 is deenergized by interrupting the electric current supplied from the battery to disappear the magnetic field. The shift rod 210 is then free from the magnetic field. The return spring 230 urges the shift rod 210 toward its original position, as shown in FIG. 6. At that time, the differential clutch gear connected to one end of the fork 220 is returned together with the shift rod, and thus is detached from the connecting shaft clutch gear to achieve the two-wheel drive.

With the construction described above, the shift of the connecting shaft to the four-wheel drive mode or the two-wheel drive mode may be easily achieved by the electromagnet. In addition, since a constant level of the electric current is applied to the electromagnet from the battery of the vehicle, it is possible to stably shift the running mode. The simplified construction of the device of present invention will also facilitate the maintenance thereof. Furthermore, the decreased number of the parts decreases the overall weight of the vehicle.

The forgoing embodiment is merely exemplary and is not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

What is claimed is:

1. A power control device for use in a four-wheel drive vehicle with a part-time four-wheel drive system, in which one side of a differential is connected to a differential clutch gear and cooperates with a connecting shaft clutch gear for power transmission, the power controlling device comprising:
an electromagnet;
a shift rod operated by a magnetic field generated by the electromagnet to selectively position the differential clutch gear for cooperation with the connecting shaft gear; and
a return spring, positioned between the electromagnet and the shift rod, for constantly biasing the shift rod toward an original position thereof.

2. The power control device as claimed in claim 1, wherein the electromagnet is positioned within an interior of a differential case, and an electric current is applied to the electromagnet from electric power from the vehicle.

3. The power control device as claimed in claim 1, wherein the shift rod has on one end thereof a fork engaging to the differential clutch gear.

4. A power control device for a switchable four-wheel drive system in a vehicle, comprising:
a connecting shaft clutch gear delivering drive power to front wheels of the vehicle;
a differential clutch gear moveably disposed for selective cooperation with the connecting shaft clutch gear for selective transmission of power to a front wheel differential;
a rod member slidably disposed adjacent said differential clutch gear, said rod member cooperating with the differential clutch gear to impart axial translation thereto;
an electromagnet disposed to act on said rod member to move said member in a first direction when activated; and
a spring member acting on said rod member to move said rod member in an opposite direction when the electromagnet is deactivated.

5. The power control device as in claim 4, further comprising a fork member extending from the rod member to engage the differential clutch gear.
